(19) United States
(12) Patent Application Publication
(10) Pub. No.: US 2023/0031866 A1
(43) Pub. Date: Feb. 2, 2023

(54) System and method for remote audio recording

(71) Applicant: Stude Ltd., London (GB)

(72) Inventor: James HUDSON, London (GB)

(21) Appl. No.: 17/876,175

(22) Filed: Jul. 28, 2022

(30) Foreign Application Priority Data
Jul. 28, 2021 (GB) 2110873.3

(51) Int. Cl. H04L 65/75; H04L 65/80; H04L 47/28; H04L 47/32

(52) U.S. Cl. CPC H04L 65/75; H04L 65/80; H04L 47/28; H04L 47/32

(57) ABSTRACT

In one aspect, a method of making an audio recording in a recording session comprises sending a first audio packet from a first device to a second device, the first audio packet comprising a portion of a first audio signal for playback at the second device; receiving at the first device a second audio packet from the second device, the second audio packet comprising a portion of a second audio signal, the second audio signal being created at the second device during playback of the first audio signal by the second device; delaying the second audio packet by an first adjustment latency, wherein the first adjustment latency is set so that a total delay between the first audio packet sent by the first device and the second audio packet received by the first device from the second device equals a fixed audio packet delay for the recording session.

### FIELD

Embodiments described herein relate generally to a method and system for audio recording, in particular, to real-time, high quality audio conferencing, between non-co-located participants.

### BACKGROUND

With an increasing amount of business and productivity moving online, the latency and quality challenges of remote recording of audio have prevented the music industry from being able to efficiently manage remote recording sessions. A remote recording session is a recording session in which the producer and artists and are not located in the same room or location, i.e. they are non-co-located. Being able to record artists remotely as if they were physically present in the same room would give a huge productivity boost, and reduce the need for physical recording studios, or travel for artists.

Arrangements of the present invention will be understood and appreciated more fully from the following detailed description, made by way of example only and taken in conjunction with drawings in which:

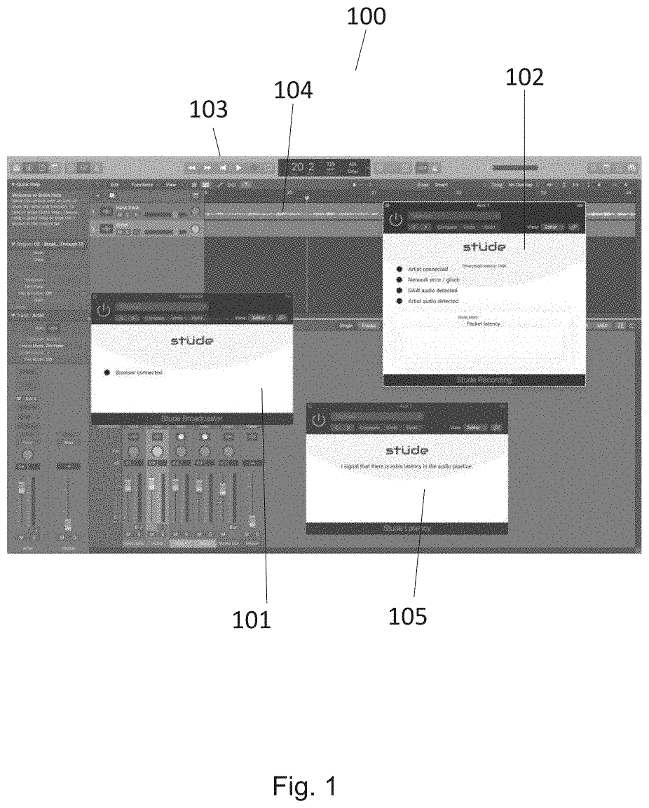

FIG. 1 illustrates an interface of a digital audio workstation;

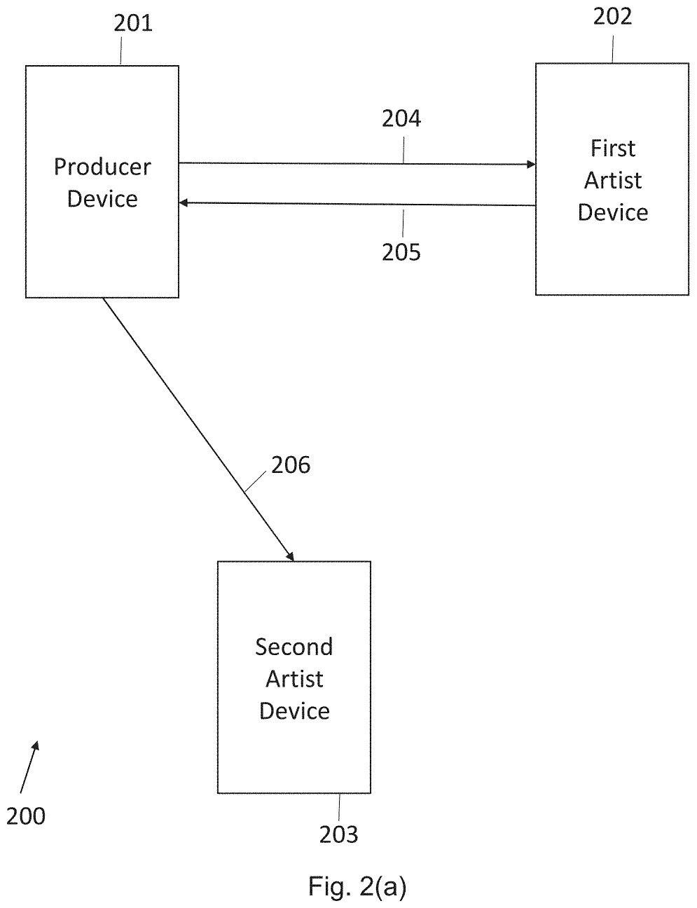

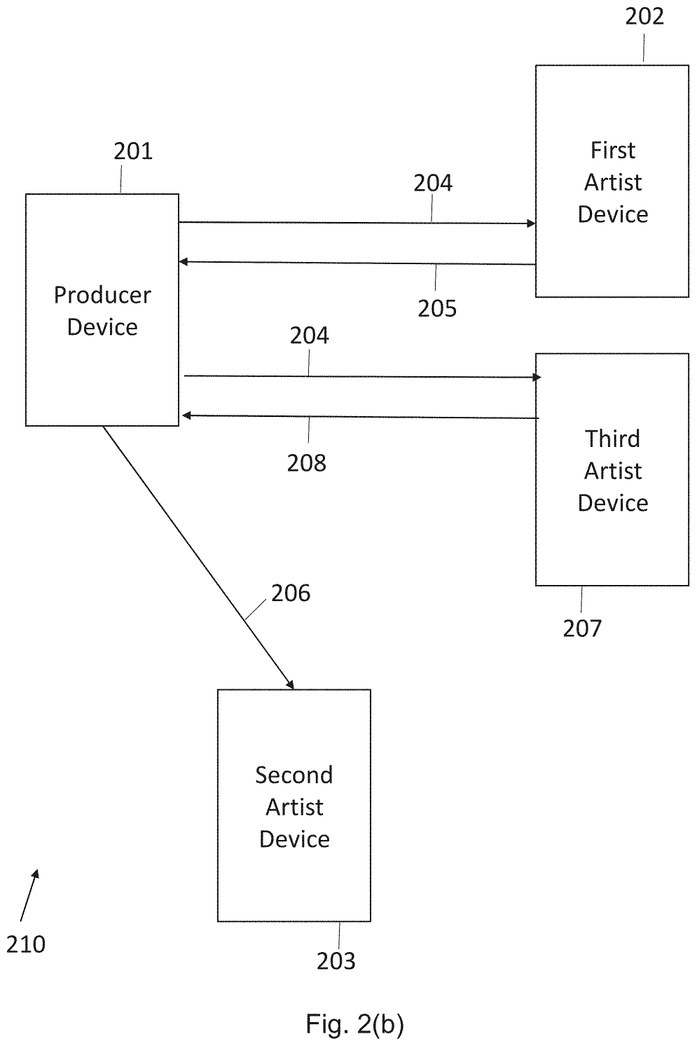

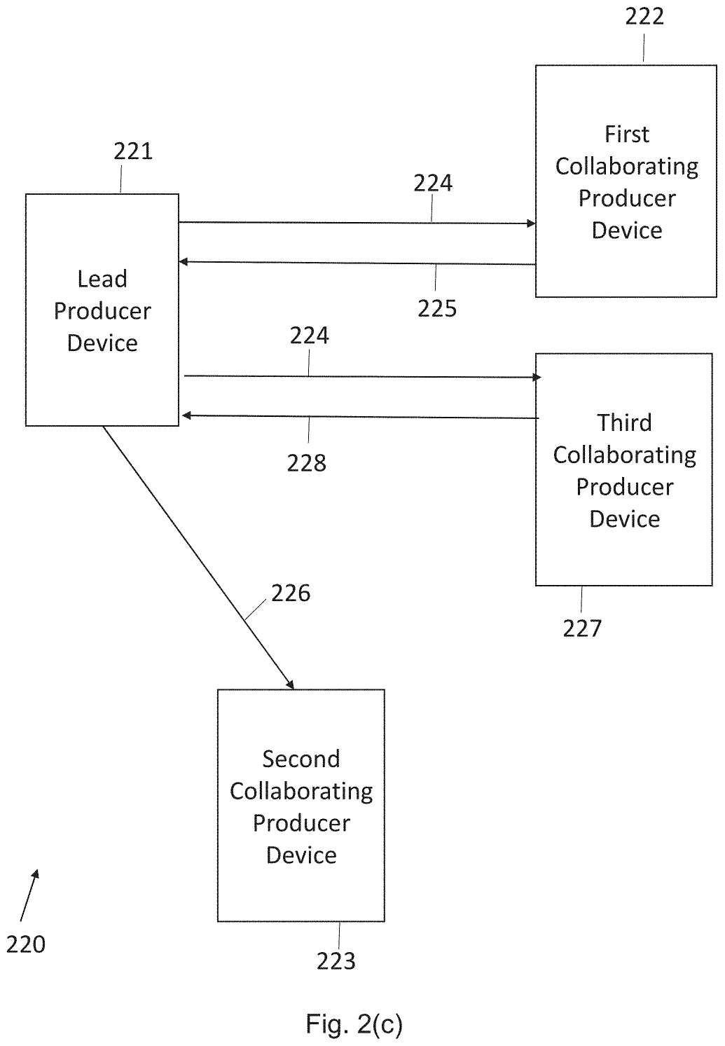

FIG. 2(a) illustrates a system according to an embodiment;

FIG. 2(b) illustrates a system according to an embodiment;

FIG. 2(c) illustrates a system according to an embodiment;

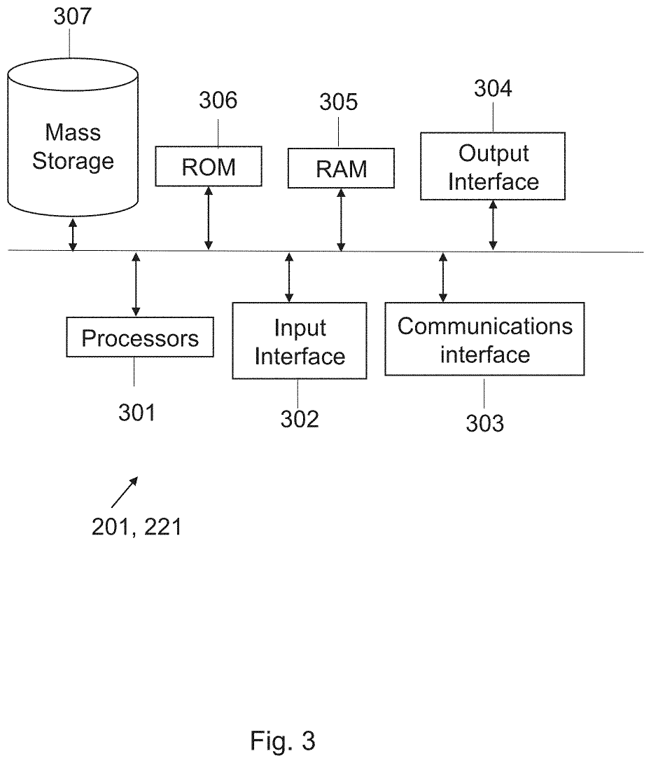

FIG. 3 illustrates a producer device according to an embodiment;

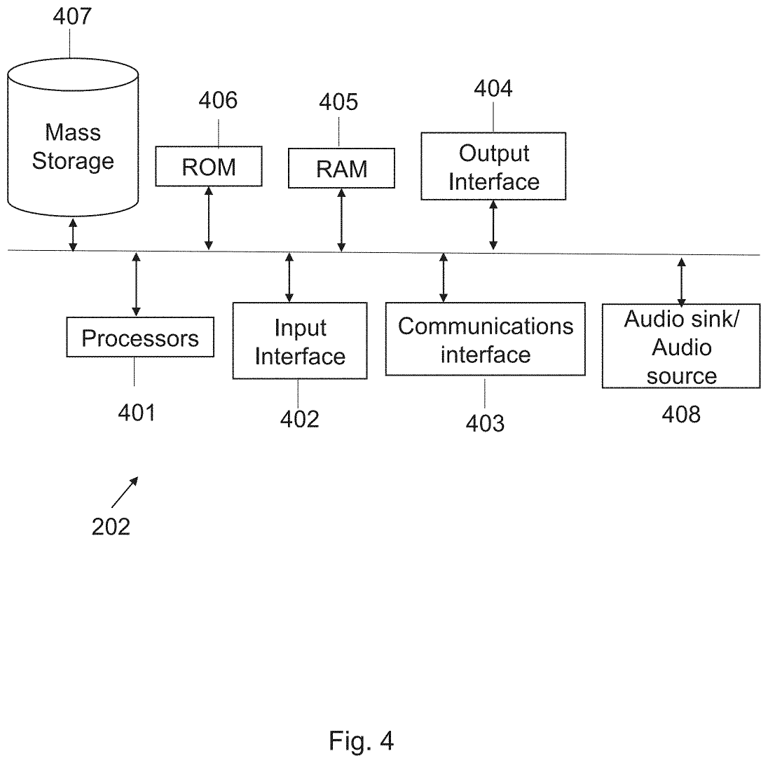

FIG. 4 illustrates a first artist device according to an embodiment;

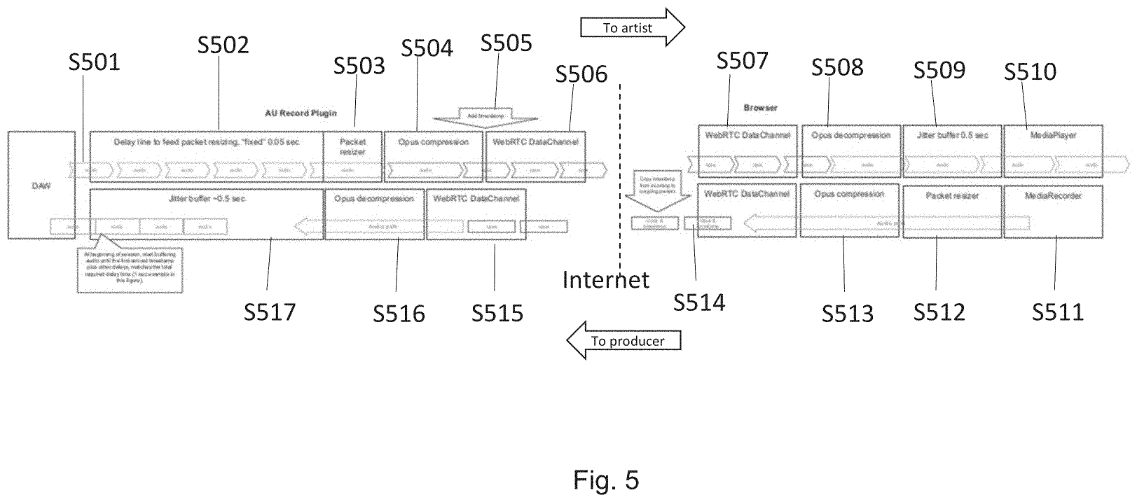

FIG. 5 illustrates a flow chart of a method according to an embodiment;

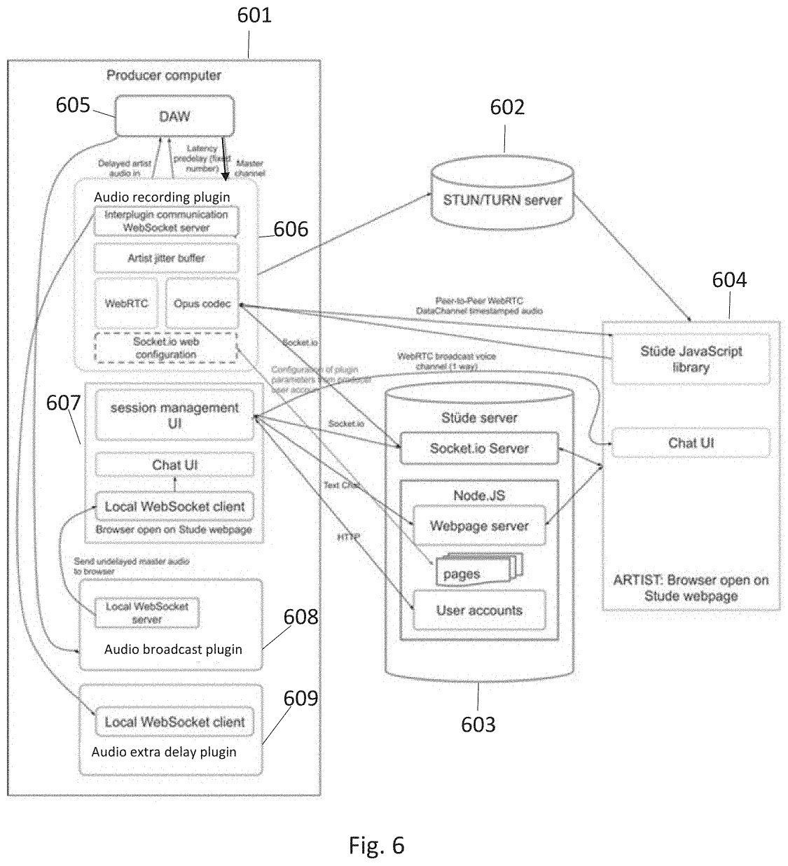

FIG. 6 illustrates a system according to an embodiment;

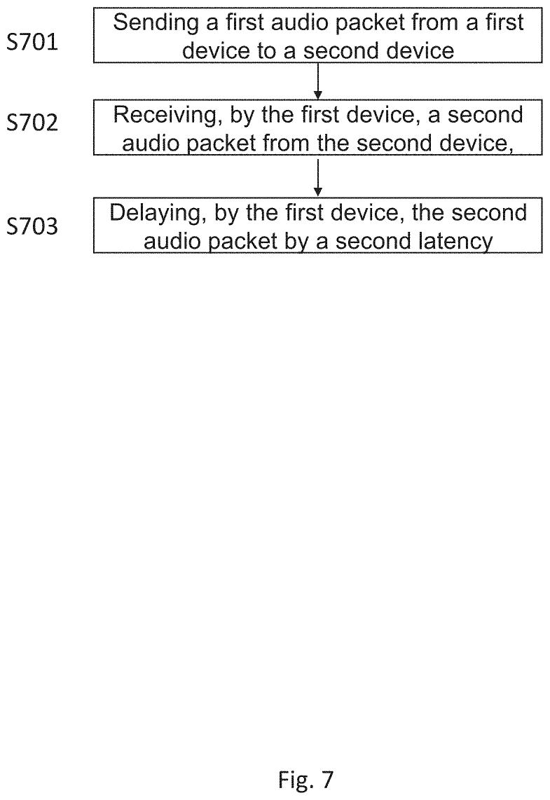

FIG. 7 shows a flowchart of a method according to an embodiment; and

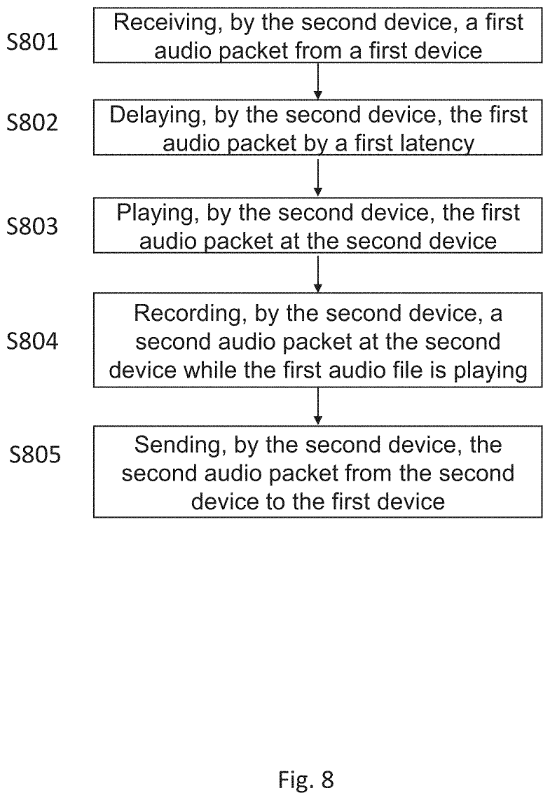

FIG. 8 shows a flowchart of a method according to an embodiment.

### DETAILED DESCRIPTION

According to a first aspect of the invention, there is provided a method of making an audio recording in a recording session, the method comprising: sending a first audio packet from a first device to a second device, the first audio packet comprising a portion of a first audio signal for playback at the second device; receiving at the first device a second audio packet from the second device, the second audio packet comprising a portion of a second audio signal, the second audio signal being created at the second device during playback of the first audio signal by the second device; delaying the second audio packet by a first adjustment latency, wherein the first adjustment latency is set so that a total delay between the first audio packet sent by the first device and the second audio packet received by the first device from the second device equals a fixed audio packet delay for the recording session.

This ensures the recorded audio is always delayed by a fixed known amount compared to the first audio packet. By incorporating this delay into the DAW, both audios will be in sync at the DAW.

In an embodiment, the first audio packet is a backing track.

In an embodiment, the second audio packet is the audio being recorded remotely, from a location removed from the first device, or over the internet.

According to an embodiment, the first adjustment latency is determined based on the fixed audio packet latency, a latency of a browser running on the second device, a round trip latency, and a second adjustment latency, wherein a round trip delay is the time it takes for a packet to be sent from the first device to the second device, and from the second device to the first device, wherein the second adjustment latency is a delay of the first audio packet at the second device.

This takes into account latencies in the system so that the fixed audio packet delay can be accurately maintained at a fixed value.

According to an embodiment, the method further comprises: prior to sending the first audio packet to the second device, adding a timestamp to the first audio packet, receiving a third audio packet from the second device, wherein the third audio packet comprises the timestamp from the first audio packet: and determining a round trip delay based on the timestamp.

This enables the determination of the round trip delay, and hence, maintenance of the fixed audio packet delay at a known fixed value.

According to an embodiment, the method further comprises: determining the latency of the browser by: receiving, from the second device, a delay between a first audio test signal played on the second device and a second audio test signal recorded on the second device, wherein the second audio test signal is a recording of the first audio test signal being played on the second device.

This provides an audio loopback test that allows he delays in the artist browser to be determined.

According to an embodiment, the first device and second device comprise at least one buffer, and if the total delay between the first audio packet sent by the first device and the second audio packet received by the first device from the second device exceeds the fixed audio packet delay or if a buffer of the first device or second device is empty, discarding the first audio packet, the second audio packet and packets in the at least one buffer of the first device and the at least one buffer of the second device.

The initialisation process begins again, and the buffers are then re-filled with new audio. This introduces a silent period in the recorded audio, but keeps the following audio synchronised.

This ensures that the maintenance of the fixed audio packet delay at a known fixed value at the cost of packet loss, rather than allowing delay to occur in the system.

According to an embodiment, the first device and the second device comprise at least one buffer, and the method further comprises prior to sending the first audio packet to the second device, sending a control packet from the first device to the second device, wherein the control packet indicates to the second device to empty the at least one buffer on the second device. This ensure that the second device is ready to commence a new recording session and to begin refilling its buffers.

According to an embodiment, the control packet indicates to the second device to commence sending of audio packets from the second device to the first device. Therefore, the first device can initiate the second device to begin sending audio packets.

According to a second aspect of the invention, there is provided a method of making an audio recording in a recording session, the method comprising: receiving, by a second device, a first audio packet from a first device, the first audio packet comprising a portion of a first audio signal for playback at the second device; delaying, by the second device, the first audio packet by a second adjustment latency; playing the first audio packet at the second device; recording a second audio packet at the second device, the second audio packet comprising a portion of a second audio signal, the second audio signal being created at the second device during playback of the first audio signal by the second device; sending the second audio packet from the second device to the first device; wherein the second adjustment latency is set so that a total delay between the first audio packet sent by the first device and the second audio packet received by the first device from the second device equals a fixed audio packet delay for the recording session.

This ensures the recorded audio is always delayed by a fixed known amount compared to the first audio packet. By incorporating this delay into the DAW, both audios will be in sync at the DAW.

In an embodiment, the first audio packet is a backing track.

In an embodiment, the second audio packet is the audio being recorded remotely, from a location removed from the first device, or over the internet.

According to an embodiment, the second adjustment latency is determined based on the fixed audio packet delay and a latency of a browser running on the second device.

This takes into account latencies in the system so that the fixed audio packet delay can be accurately maintained at a fixed value.

According to an embodiment, the method further comprises: on receiving the first audio, adding, by the second device, a timestamp from the first audio packet to a third audio packet, the third audio packet recorded at the second device; and sending the third audio packet to the first device.

According to an embodiment, the method further comprises determining the latency of the browser by: playing a first audio test signal on the second device; recording a second audio test signal, wherein the second audio test signal is a recording of the first audio test signal being played at the second device; determining a delay between the audio test signal and the recorded audio test signal at the first device; and sending, to the first device, the delay between the audio test signal and the recorded audio test signal at the first device.

This provides an audio loopback test that allows the delays in the artist browser to be determined.

According to an embodiment, the method further comprises, wherein the first device and second device comprise at least one buffer, wherein if the total delay between the first audio packet sent by the first device and the second audio packet received by the first device from the second device exceeds the fixed audio packet delay, or if a buffer of the first device or second device is empty, discarding the first audio packet, the second audio packet and packets in the at least one buffer of the second device and the at least one buffer of the first device.

According to an embodiment, the first device and the second device comprise at least one buffer, the method further comprises prior to sending the first audio packet to the second device, receiving, by the second device, a control packet from the first device to the second device; in response to receiving the control packet, emptying, by the second device, the at least one buffer on the second device.

According to an embodiment, the method further comprises in response to receiving the control packet, commencing sending of audio packets from the second device to the first device.

This ensures that the maintenance of the fixed audio packet delay at a known fixed value at the cost of packet loss, rather than allowing delay to occur in the system.

According to a third aspect of the invention, there is provided a non-transitory storage media comprising instructions that when executed by a computer, causes the computer to perform the method described above.

According to a fourth aspect of the invention, there is provided a producer device suitable for use in a recording session the producer device comprising a processor, memory and a communications interface, the producer device configured to: send a first audio packet to an artist recording device, the first audio packet comprising a portion of a first audio signal for playback at the artist recording device; receive a second audio packet from the artist recording device, the second audio packet comprising a portion of a second audio signal, the second audio signal being created at the artist recording device during playback of the first audio signal by the artist recording device; and delay the second audio packet by a first adjustment latency, wherein the first adjustment latency is set so that a total delay between the first audio packet sent by the producer device and the second audio packet received at the producer device from the artist recording device equals a fixed audio packet delay for the recording session.

The artist recording device is any device which can create music through recording external instruments/voice through microphones, or by recording music created digitally within the device.

This ensures the recorded audio is always delayed by a fixed known amount compared to the first audio packet. By incorporating this delay into the DAW, both audios will be in sync at the DAW.

In an embodiment, the first audio packet is a backing track.

In an embodiment, the second audio packet is the audio being recorded remotely, from a location removed from the first device, or over the internet.

According to an embodiment, the first adjustment latency is determined based on the fixed audio packet latency, a latency of a browser running on the second device, a round trip latency, and a second adjustment latency, wherein a round trip delay is the time it takes for a packet to be sent from the first device to the second device, and from the second device to the first device, wherein the second adjustment latency is a delay of the first audio packet at the second device.

This takes into account latencies in the system so that the fixed audio packet delay can be accurately maintained at a fixed value.

According to an embodiment, the producer device is further configured to: prior to sending the first audio packet to the artist recording device, add a timestamp to the first audio packet, receiving a third audio packet from the second device, wherein the third audio packet comprises the timestamp from the first audio packet; and determine a round trip delay based on the timestamp.

This enables the determination of the round trip delay, and hence, maintenance of the fixed audio packet delay at a known fixed value.

According to an embodiment, the producer device is further configured to determine the latency of the browser by: receiving from the artist recording device a delay between a first audio test signal played on the artist recording device and a second audio test signal recorded on the artist recording device, wherein the second audio test signal is a recording of the first audio test signal being played at the artist recording device.

This provides an audio loopback test that allows the delays in the artist browser to be determined.

According to an embodiment, the producer device is further configured to: wherein the producer device and the artist recording device comprise at least one buffer, wherein if the total delay between the first audio packet sent by the producer device and the second audio packet received by the producer device from the artist recording device exceeds the fixed audio packet delay, or if a buffer of the producer device or artist recording device is empty, discard the first audio packet, the second audio packet and packets in the at least one buffer of the producer device and the at least one buffer of the artist device.

This ensures that the maintenance of the fixed audio packet delay at a known fixed value at the cost of packet loss, rather than allowing delay to occur in the system.

According to an embodiment, the producer device and the artist recording device comprise at least one buffer, the producer device further configured to: prior to sending the first audio packet to the artist recording device, send a control packet from to the artist recording device, wherein the control packet indicates to the artist recording device to empty the at least one buffer on the artist recording device

According to an embodiment, the control packet indicates to the artist recording device to commence sending of audio packets to the producer device.

According to a fifth aspect of the invention there is provided an artist recording device suitable for use in a recording session, the artist recording device comprising a processor, memory, a communications interface, and an audio transducer, the artist recording device configured to:

receive a first audio packet from a producer device, the first audio packet comprising a portion of a first audio signal for playback at the second device; delay the first audio packet by a second adjustment latency; play the first audio packet at the artist recording device; record a second audio packet at the artist recording, the second audio packet comprising a portion of a second audio signal, the second audio signal being created at the second device during playback of the first audio signal by the second device; send the second audio packet from the artist recording device to the producer device; wherein the second adjustment latency is set so that a total delay between the first audio packet sent by the producer device and the second audio packet received by the producer device from the artist recording device equals a fixed audio packet delay for the recording session.

This ensures the recorded audio is always delayed by a fixed known amount compared to the first audio packet. By incorporating this delay into the DAW, both audios will be in sync at the DAW.

In an embodiment, the first audio packet is a backing track.

In an embodiment, the second audio packet is the audio being recorded remotely, from a location removed from the first device, or over the internet.

According to an embodiment, the second adjustment latency is determined based on the fixed audio packet delay and a latency of a browser running on the artist recording device.

This takes into account latencies in the system so that the fixed audio packet delay can be accurately maintained at a fixed value.

According to an embodiment the artist recording device is further configured to: on receiving the first audio packet, add a timestamp from the first audio packet to a third audio packet, the third audio packet recorded at the second device; and sending the third audio packet to the first device.

According to an embodiment the artist recording device is further configured to: determine the latency of the browser by: playing a first audio test signal on the artist recording device; recording a second audio test signal, wherein the second audio test signal is a recording of the first audio test signal being played at the artist recording device; determining a delay between the audio test signal and the recorded audio test signal at the artist recording device; and sending, to the producer device, the delay between the audio test signal and the recorded audio test signal at the artist recording device.

This provides an audio loopback test that allows the delays in the artist browser to be determined.

According to an embodiment, the second device is further configured to: wherein the producer device and artist recording device comprise at least one buffer, wherein if the total delay between the first audio packet sent by the producer device and the second audio packet received by the producer device from the artist recording device exceeds the fixed audio packet delay, or if a buffer of the producer device or artist recording device is empty, discard the first audio packet, the second audio packet, and packets in the at least one buffer of the artist recording device and the at least one buffer of the producer device.

This ensures that the maintenance of the fixed audio packet delay at a known fixed value at the cost of packet loss, rather than allowing delay to occur in the system.

According to an embodiment, the producer device and the artist recording device comprise at least one buffer, the artist recording device further configured to prior to receiving the first audio packet from the producer device, receive, by the artist recording device, a control packet from the producer device; in response to receiving the control packet, empty the at least one buffer on the artist recording device.

According to an embodiment, an artist recording device further configured to: in response to receiving the control packet, commence sending of audio packets to the producer device.

According to a sixth aspect of the invention, there is provided a system comprising a producer device, as described above, and an artist recording device, as described above.

A digital audio workstation (DAW) is system used by music producers to record and manage recording sessions. FIG. 1 shows an example interface of a DAW. The DAW interface comprises various regions, or panes, for different functions. A Stude broadcaster plugin 101 allows the producer to broadcast any audio tracks into their browser's current Stude chat session.

A recording plugin 102 allows the producer to record a remote artist, or collaborate with a remote producer, and automatically compensate for any latency in the round trip of the audio. It shows some indicators to indicate the status of the connection with the artist, including:
The total extra latency of every other Stude plugin in the system
An artist is connected to the plugin
A temporary network error occurred during recording, which introduced corruption into the recorded audio from the artist. This might be a break in the Internet connection, or latency that is so great it could not be compensated for by the system.
If audio is detected from the DAW being sent into the plugin
If audio is detected coming back from the remote artist to the plugin
A packet latency graph (with green line) gives a visual representation of the network latency to the producer.

A toolbar 103 provides buttons to play audio or record audio, as well as a display of features of the audio such as bar, beat, tempo, time signature and chord. The play and record button click actions of the producer are detected by the recording plugin, to automatically begin an audio connection with the artist.

A display area 104 also displays a visual representation of the input track, or backing track, and the artist's performance. It includes a “transport”, which indicates at which time point audio is currently being played or recorded.

A Stude latency plugin 105 adds extra latency compensation to the recording pipeline. This is because some DAWs only allow a maximum of 1 second of latency compensation to be added per plugin, and it may be necessary to compensate for more than 1 second of network latency.

A recording session carried out by a producer and artists is detailed below.

The DAW provides a chat room for interaction with each artist. A chat room is an internet based application which provides a facility which can be used by the participating artists to communicate by writing text messages to each other. Alternatively the chat room may allow artists to communicate using audio and or video.

In another embodiment, the chat room is provided separately from the DAW.

In the chat room, each artist is represented by a name, icon, photo or video. In the user interface presented to the producer, a record button is provided next to each artist's representation. The producer presses the record button next to the artist that they wish to record (selected artist).

The producer then goes to the DAW and presses a record button, for example, located on the toolbar of the DAW. The selected artist hears audio, such as a backing track, intended to aid the artist to sing or perform. The artist's voice, or instrumental performance, is then recorded through the computer microphone. The artist recording is sent back to the producer. In an embodiment, the other artists in the chat can hear the selected artist's recording with the backing track.

There will be delays associated with the artist recording. The producer therefore needs to adjust the artist recording, adjusting for the delays so that the backing track and artist recording are synchronised and have no delay between them.

If other artists need to be recorded, the producer then selects the next artist and begins the recording.

In an embodiment, the artist device may be running a DAW. In an embodiment, the artist is a collaborating producer, with the artist device running a DAW. In these embodiments, the backing track is played in the DAW of the selected artist's device, The artist can then create a new track through the DAW in response to hearing the backing track, The new track may be created using instruments or voices recorded through a microphone in communication with the DAW. Alternatively, it may be created using a synthesizer in communication with the DAW. Alternatively, it be digitally created in the DAW. The new track is sent back to the producer. In an embodiment, the other artists in the chat can hear the selected artist's new track synchronized with the backing track.

For a recording involving multiple artists, the producer will need to stop after each artist has recorded to adjust the audio track so that there is no delay with respect to the backing tracks and any recorded audio tracks, or new tracks, provided by the artists. There is no existing single piece of software to provide for a recording session as described above. Instead, only separate software is available which are often used haphazardly, with much manual intervention.

There is a need for a system that allows the producer to keep recording and not have to stop the session.

FIG. 2(a) illustrates a system 200 according to an embodiment. A producer device 201, a first artist device 202 and, a second artist device 203 are being used to facilitate a remote recording session. The producer device 201, the first artist device 202 and, the second artist device 203 are computer or mobile devices in structure and function. They may share certain features with a general purpose computer apparatus, but some features may be implementation specific, given the specialised function for which the devices are to be used. The reader will understand which features can be of general-purpose type, and which may be required to be configured specifically for use in the current context.

The producer device 201 sends a backing track 204 to the first artist device 202. The first artist at the first artist device 202 sings, or performs, in response to hearing the backing track 204. The first artist's voice or musical instrument is recorded at the first artist device 202 and the voice/instrument track 205 is sent to the producer device 201. The producer device 201 sends the combined track 206, comprising the backing track 204 and the voice/instrument track 205, to the second artist device 203 for the second artist to listen to.

In an embodiment, the second artist device 203 is not present, and the recording session comprises only the producer device 201 and the first artist device 202. In a further embodiment, the recording session comprises additional artist devices.

FIG. 2(b) illustrates a system 210 according to a further embodiment. A producer device 201, a first artist device 20, a second artist device 203 and a third artist device 207 are being used to facilitate a remote recording session. The producer device 201, the first artist device 202, the second artist device 203 and the third artist device 207 are computer or mobile devices in structure and function. They may share certain features with a general purpose computer apparatus, but some features may be implementation specific, given the specialised function for which the devices are to be used. The reader will understand which features can be of general-purpose type, and which may be required to be configured specifically for use in the current context.

The producer device 201 sends a backing track 204 to the first artist device 202. The first artist at the first artist device 202 sings, or performs, in response to hearing the backing track 204. The first artist's voice or musical instrument is recorded at the first artist device 202 and the voice/instrument track 205 is sent to the producer device 201.

At the same time the as sending a backing track 204 to the first artist device 202, the producer device, sends the backing track 204 to the third artist device 207. The third artist at the third artist device 207 sings, or performs, in response to hearing the backing track 204. The third artist's voice or musical instrument is recorded at the third artist device 204 and the third artist voice/instrument track 208 is sent to the producer device 201.

The producer device 201 sends the combined track 207 to the second artist device 203 for the second artist to listen to. In this embodiment, the combined track 206 comprises the backing track 204, the first artist voice/instrument track 205, and the third artist voice instrument track 208.

Although FIGS. 2(a) and 2(b) illustrate two and three artist devices respectively, there is no limit on the number of artists that may be included in the recording session.

Instead of artist devices, such as the first artist device 202, the second artist device 203 and the third artist device 207, the producer may be recording a session with collaborating producer devices, as illustrated in FIG. 2(c).

As detailed above, any of the artist devices may be a producer device. For completion, FIG. 2(c) illustrates a system 220 wherein the artist devices are producer devices. A lead producer device 221, a first collaborating producer device 222, a second collaborating producer device 223 and a third collaborating producer device 227 are being used to facilitate a remote recording session. The lead producer device 221, the first collaborating producer device 222, the second collaborating producer device 223 and the third collaborating producer device 227 are computer or mobile devices in structure and function. They may share certain features with a general purpose computer apparatus, but some features may be implementation specific, given the specialised function for which the devices are to be used. The reader will understand which features can be of general-purpose type, and which may be required to be configured specifically for use in the current context.

The producer device 221 sends a backing track 224 to the first collaborating producer device 222. The producer at the first collaborating producer device 221, in response to hearing the backing track 224, may digitally edit the backing track 224 or digitally compose a new track. The new track 225 created by the producer at the first collaborating producer device 222 is sent to the lead producer device 221. The lead producer device 221 sends the combined track 226, comprising the backing track 224 and the new track 225, to the second collaborating producer device 223 for the producer at the second collaborating producer device 223 to listen to.

In an embodiment, the second collaborating producer device 223 is not present, and the recording session comprises only the lead producer device 221 and the first collaborating producer device 222. In a further embodiment, the recording session comprises additional collaborating producer devices, such as the third collaborating producer device 227.

In an embodiment, at the same time the as sending a backing track 224 to the first collaborating producer device 222, the lead producer device 221, sends the backing track 224 to the third collaborating producer device 227. The producer at the third collaborating producer device 227, in response to hearing the backing track 224, may digitally edit the backing track 224 or digitally compose a new track. The new track 228 is sent to the lead producer device 221.

The lead producer device 221 sends the combined track 226 to the second collaborating producer device 223 for the producer at that device to listen to. In this embodiment, the combined track 226 comprises the backing track 224, the new track 225 from the first collaborating producer device 222, and the new track 228 from the third collaborating producer device 227.

In an embodiment, at least one of the first collaborating producer 222, second collaborating producer device 223 and the third collaborating producer device 227 is replaced by an artist device, for example the first artist device 202, the second artist device 203 or the third artist device 207 of FIG. 2(c). In an embodiment, the system may comprise additional artist devices or producer devices.

FIG. 3 illustrates the producer device 201 or the lead producer device 221 of FIG. 2(a) to 2(c). The producer device 201 221 comprises one or more processors 301, either generally provisioned, or configured for other purposes such as mathematical operations, audio processing, managing a communications channel, and so on.

An input interface 302 provides a facility for receipt of user input actions. Such user input actions could, for instance, be caused by user interaction with a specific input unit including one or more control buttons and/or switches, a touchscreen, a keyboard, a mouse or other pointing device, a microphone, a speech recognition unit enabled to receive and process speech into control commands, a signal processor configured to receive and control processes from another device such as a tablet or smartphone, or a remote-control receiver. This list will be appreciated to be non-exhaustive and other forms of input, whether user initiated or automated, could be envisaged by the reader.

Likewise, an output interface 304 is operable to provide a facility for output of signals to a user or another device. Such output could include a display signal for driving a local video display unit (VDU), audio speakers, headphones or any other device.

A communications interface 303 implements a communications channel with one or more recipients of signals. In the context of the present embodiment, the communications interface is configured to send audio to the first artist device and receive audio from the first artist device.

The processors 301 are operable to execute computer programs, in operation of the producer device 201. In doing this, recourse is made to data storage facilities provided by a mass storage device 307 which is implemented to store computer programs, such as a DAW program and associated plugin.

A Read Only Memory (ROM) 306 is preconfigured with executable programs designed to provide the core of the functionality of the component 201, and a Random Access Memory 305 is provided for rapid access and storage of data and program instructions in the pursuit of execution of a computer program.

The first artist device 202 is shown in FIG. 4. The first artist device 202 comprises one or more processors 401, either generally provisioned, or configured for other purposes such as mathematical operations, audio processing, managing a communications channel, and so on.

An input interface 402 provides a facility for receipt of user input actions. Such user input actions could, for instance, be caused by user interaction with a specific input unit including one or more control buttons and/or switches, a touchscreen, a keyboard, a mouse or other pointing device, a microphone, a speech recognition unit enabled to receive and process speech into control commands, a signal processor configured to receive and control processes from another device such as a tablet or smartphone, or a remote-control receiver. This list will be appreciated to be non-exhaustive and other forms of input, whether user initiated or automated, could be envisaged by the reader.

Likewise, an output interface 404 is operable to provide a facility for output of signals to a user or another device. Such output could include a display signal for driving a local video display unit (VDU), audio speakers, headphones or any other device.

A communications interface 403 implements a communications channel with one or more recipients of signals. In the context of the present embodiment, the communications interface is configured to receive audio from the producer device and send audio to the producer device.

The processors 401 are operable to execute computer programs, in operation of the first artist device 202. In doing this, recourse is made to data storage facilities provided by a mass storage device 407 which is implemented to store computer programs, browser interfaces etc.

A Read Only Memory (ROM) 406 is preconfigured with executable programs designed to provide the core of the functionality of the component 202, and a Random Access Memory 405 is provided for rapid access and storage of data and program instructions in the pursuit of execution of a computer program.

The first artist device 202 may also comprise audio sinks and/or audio sources 408 such as speakers for playing audio, microphones for recording audio, or the input or output to a DAW running on the first artist device 202.

The second artist device 203, the third artist device 207, the first collaborating producer device 222, the second collaborating producer device 223, and the third collaborating producer device 227 or any further artist devices may be similar to the first artist device 202 as shown in FIG. 4.

FIG. 5 illustrates a recording plugin integrated into a DAW and an artist browser interface according to an embodiment. The DAW can be a third-party piece of music production software which provides a standard API to the developed plugin.

Although an artist browser is referred to in the embodiment below, the artist browser may be replaced by an app, plugin, DAW plugin, software or other such means of executing the described method.

While FIG. 5 is described below with relation to an artist device, it is clear from FIG. 2(a) to FIG. 2(c) and the accompanying description above, that the artist device may be a collaborating producer device.

At S501, individual packets of audio from a track, such as a backing track, are selected in the DAW. For example, each packet can be 20 ms in length.

In an embodiment, the packets are part of an audio data stream. The audio data streams are broken up into audio packets for processing and transmission, and reassembled into continuous audio when they are to be played or recorded. An audio data stream comprises a plurality of audio data packets, wherein each audio data packet contains audio coded information corresponding to a time slot of an audio signal, together with metadata or side information intended to enable decoding of the audio coded information into a reconstructed version of the time slot of the audio signal.

At S502, the packets pass through a master delay line. The delay line may have a delay of 0.05 seconds. However, the delay line may have delays other than 0.05 seconds. The total time delay accomplished by the delay line is equal to the length multiplied by the sample time (n·t) (http://basicsynth.com/index.php?page=delaylines).

Then at S503, the packets are then resized. For example, the packets provided by the DAW may vary in size, but are typically about 23 ms. The compressor (see step S504), for example the Opus compressor, takes 20 ms packets. Therefore, the approximately 23 ms packets from the DAW need to be bundled together into a 20 ms packet before implementing step S504.

The packets are then compressed for transmission at S504. This may be achieved using the Opus codec (https://opus-codec.org). The Opus codec is versatile as it can be used efficiently for everything from poor-quality voice calls to professional audiophile quality. The Opus code is also becoming the standard for web audio (https://en.wikipedia.org/wiki/Opus_(audio_format)).

However, other codecs may be used. For example, FLAC lossless (https://xiph.org/flac/) may be used for perfect quality, or AAC (https://en.wikipedia.org/wiki/Advanced_Audio_Coding) may be used.

Following compression, the plugin appends a timestamp to the data packet at S505. The timestamp is captured from the DAW at the time that the audio packet begins playing in the DAW, i.e. when the producer hits record. The timestamp may be the exact time when the audio has been playing (64 bit Unix epoch, in milliseconds). Alternatively, the timestamp may be the exact audio position or sample of the packet in the track. Alternatively, the timestamp may come from an external clock.

The plugin then buffers multiple compressed packets until they are the optimum size for network transmission, and then sends them over a data channel, such as a Web Real-Time Communication (WebRTC) channel at S506.

This WebRTC DataChannel is set up as follows. The DAW plugin takes a server role, and listens for a Socketio websocket connection. The producer informs the server which recordee (the “artist”) should be connected via a recording button in the chat room, and the correct artist's web browser session is told to make a WebRTC connection to the plugin through a negotiation server.

The audio connection is immediately created, so the round-trip latency can begin being estimated (see below). However, other types of data channels may be used.

The artist browser interface is the counterpart to the DAW with recording plugin mentioned above. It records the audio from the artist and performs approximately the reverse operations of the DAW with recording plugin mentioned above.

When the data packet is received by the artist browser interface at S507 the timestamp appended to the data packet (S505) is copied and appended to a data packet at 5514 that is being sent back to the plugin at S514. This is done immediately, or as soon as possible, after receiving the data packet with the appended timestamp. This enables the determination, by the plugin, of the round trip delay over the data channel, such as a WebRTC DataChannel, between the plugin and the artist browser.

The artist browser interface decompresses the compressed audio at S508. It fills a jitter buffer at S509 and then plays the audio through the web browser media player, or through a DAW, at S5010.

The artist browser interface then records the artist's microphone audio using the media recorder at S511. Alternatively, the artist browser interface receives a new audio track from the DAW running on the artist device.

In an embodiment, the recording, or new track, is an audio data stream comprising a plurality of packets. An audio data stream is broken up into audio packets for processing and transmission, and reassembled into continuous audio when they are to be played or recorded. An audio data stream comprises a plurality of audio data packets, wherein each audio data packet contains audio coded information corresponding to a time slot of an audio signal, together with metadata or side information intended to enable decoding of the audio coded information into a reconstructed version of the time slot of the audio signal.

Each packet is resized at S512 and compressed at S513. The compression may be achieved using Opus codec (https://opus-codec.org), but other methods may be used as detailed above. At S514, the artist browser interface sends the new audio packet (or file) in the reverse direction through the data channel to the plugin (S515).

The DAW with the recording plugin decompresses the compressed audio at S516. It fills a jitter buffer at S517 and then sends the audio to the DAW.

The pipeline enters a “buffer filling” state, where a series of jitter buffers on the local and remote end are filled to an optimum capacity for maintaining a constant audio stream of fixed latency.

The jitter buffer on the artist's side is filled to 50% of the total required latency minus the estimated total artist audio latency. The jitter buffer on the producer's side is filled to make up the extra latency required to match the desired latency. This approximate 50/50 split is chosen because the latency variation would be expected to be approximately equal on both the outgoing and return trips. For asymmetric upload/download network conditions, these values can be shifted accordingly. Therefore, in certain embodiment the split may not 50/50, and may be some other value of a split.

This “buffer filling” state is the critical enabler of the system: it calculates the most robust filling of the buffers, starts the audio flow at exactly the point where the total latency will match the desired latency value, and then tries to maintain a gapless flow of audio that remains at that latency for as long as possible, by adding enough delay to the system to make up the fixed, constant latency initially reported to the DAW.

While FIG. 5 shows two buffers, there can be more than two buffers. All buffers will add up to be a fixed audio packet delay for the recording sessions. For example, it may be decided that the fixed audio packet delay is 1 second. This means that the delay between the first audio packet and the second audio packet at the first device is equal to 1 seconds. In other words, the second audio packet is delayed behind the first audio packet by 1 second.

The plugin can therefore inform the DAW that there is an exact amount of latency, for example exactly 1 second or exactly 2 seconds. The DAW can then compensate for this latency by delaying the backing track so that, as long as the recorded audio is not interrupted it will stay perfectly in sync with the backing track.

The value of 1 second or 2 seconds above is arbitrary. The value could be the maximum that the DAW will allow, which in theory could be any number.

The sizes/latencies of the jitter buffer on the plugin and the jitter buffer on the artist browser are determined using the following three equations:

DAW Latency=Network Latency+Total Delay Line Latency+Artist Browser Latency Eq. (1)

The DAW Latency is the fixed audio packet delay. This is the value which the DAW is told that the total delay of the recorded track behind backing track will be at the DAW. In the examples above, it is described, as being, for example, 1 second.

Network Latency is the round trip latency of the data path in the network. This is determined using the time stamp. It uses the very first timestamp that comes through in an audio session as it is presumed that the audio will be uninterrupted from that time onwards.

The Total Delay Line Latency is the sum of all buffers/delay lines in both the producer and artist devices.

The Artist Browser Latency is unknown and needs to be determined by the plugin and artist browser. Every browser and hardware setup has slightly different latency on the artist end. This can be predicted deterministically by querying the browser and OS, or by doing a manual audio loopback test. The Artist Browser Latency may comprise a delay from when audio is played to when it comes out a speaker attached to the device. There may also be a delay between the microphone and the system. These delays may be determined using an audio loopback test. For example wherein a beep is played and recorded by the browser. The test emits a beep using device speakers that it listens for on the device's microphone. The time difference between emission and capture of the beep is the lag or audio latency. Lower is better, and 10 ms or lower is considered professional audio quality (https://superpowered.com/webbrowserlatency).

Alternatively, values for the Artist Browser Latency may be determined for various browsers, such as Chrome or Internet Explorer (https://superpowered.com/webbrowserlatency). These values may be selected in the system once it is known what browser is being used. These values would have been determined prior to the recording session.

artistJitterBufferSize=(DAW latency−Artist Browser Latency)*0.5 Eq. (2)

The Jitter buffer on the artist browser is set to be ½ of the DAW latency minus the Artist Browser Latency. This value is calculated by the DAW plugin and sent to the browser. In other words, start with the desired final DAW latency of, for example, 1 sec. Then subtract the Artist Browser Latency from that DAW latency, since it's a fixed, known contribution to the total latency, Then whatever delay is left over from that, divide it by two and assign that value to the artist jitter buffers.

requiredLatencyForSync=(DAW latency−Artist Browser Latency)−Network Latency−artistJitterBufferSize Eq. (3)

requiredLatencyForSync is how big the jitter buffer should be in the DAW plugin for all the delays to add up to one second.

As detailed above, Network Latency is the round trip latency of the data path in the network. This is determined using the time stamp. It uses the very first timestamp that comes through in an audio session as it is presumed that the audio will be uninterrupted from that time onwards.

In the case that an artist browser is replaced with a plugin, app, software or other means, then the Artist Browser Latency refers to the latency associated with that plugin, app software, or means,

In an embodiment, a timestamp is sent with every packet. This ensures that timestamps are transmitted in a lossy system, when it is not known whether a packet with a timestamp has been lost. In another embodiment, the timestamp is not sent with every packet.

If Internet falls out, or there is too much delay, then audio packets are thrown away (or discarded). For the remote recording session, it is preferred to be missing audio for a duration, say a second, then to have audio that is out of sync, chopped or not of good quality. It is preferred to fail completely and then recover quickly rather than having jitter in the audio the whole time.

Therefore, whenever the latency exceeds the fixed allowed value or any of the buffers underrun, then a “reset” message is propagated through the pipeline, and the jitter buffers re-enter this “buffer filling” state. It is preferable in the use case of music production to fail completely and reset, than to have many small buffering artefacts in the audio.

The proposed methods and systems are not concerned with minimizing or tracking latency. Instead, they are concerned with maintaining the latency in the system to be a known, fixed size and maintaining it in a round trip path by including buffers right from the start. This provides a system which is seamless for the artists and producers involved.

While FIG. 5 is described as recording a single artist, the described methods can be implemented for recording multiple artists at the same time, as illustrated in FIG. 2(b). Furthermore, as detailed above, the described methods apply for the case where the artist is a producer, or the artist is using a DAW on their device.

Prior to sending individual packets of audio from a track, (FIG. 5, S501), a control signal may be sent from the producer device to the artist. This control signal can have a timestamp sent with it. This control signal is sent along the same pathways as the individual packets of audio described above.

On receiving the control signal, the artist browser indicates to the artist device to reset the buffers on the artist device. Resetting the buffers comprises emptying the buffers on the artist device and beginning to fill them again, so as to begin a recording session.

In an embodiment where the artist device is running a DAW, on receiving the control signal the artist browser, or DAW plugin or other means, may cause the DAW running on the artist device to play, or begin data transport. This results in that the pressing of play on the DAW of the producer device would trigger the DAW on the artist device to start playing. The control signal may be sent in response to the user pressing a start button, or other means, in the DAW on the producer device.

Furthermore, at the end of the recording sessions (for example, when the backing track has completed playing), pressing stop on the DAW of the producer device may send another control signal to the artist device to trigger the DAW on the artist device to stop playing.

There is also provided a broadcast plugin which is separate from the DAW recording plugin detailed above. It connects via a local WebSocket server to the producer's browser, and allows the producer device 201 to stream any track to the other participants in the session, such as the second artist device 203 in FIG. 2. It works through normal WebRTC voice chat channels, and does not account for latency.

FIG. 6 illustrates the DAW plugin and the artist browser as part of a larger system comprising a producer computer 601, a STUN/TURN server 602, a Stude Server 603 and a browser open on a webpage referred to as the Stude webpage on an artist device 604.

On the producer computer 601, DAW software 605 is running an instance of the audio recording plugin 606, a browser open on a webpage referred to as the Stude webpage 607, optionally an audio broadcast plugin 608, and optionally any number of extra delay plugins (609).

The audio recording plugin 606 comprises:
a jitter buffer for removing latency variation (“stutter”) in the incoming audio from the artist 604,
a WebRTC connection manager for creating the P2P connection with the artist 604,
an Opus codec for compressing and decompressing the audio to and from the artist,
a Websocket server for “inter plugin communication” with other plugins, such as other Stude-branded plugins, in the same DAW, and
a socket.io web client for real-time configuration updates from the Stude server 603, and acting as a signaling server for the WebRTC module (see www.wowza.com/blog/webrtc-signaling-servers).

The audio recording plugin 606 sends timestamped audio to the browser running on the artist device 604. The browser running on the artist device 604 then sends recorded artist (voice/instrument) audio back to the AU recording plugin 606. The delayed artist audio is then sent from the audio recording plugin 606 to the DAW 605.

The artist browser open on a webpage 604 comprises:
a javascript library for connecting to the audio recording plugin 606 via WebRTC and the STUN/Turn server 602 and Stude server 603 socket.io signaling service, Opus codecs, audio buffering and processing; and
a chat UI for interacting with other participants in the session, and seeing their own recording status (“get ready to record”, “now recording” etc.).

The browser open on a webpage 607 comprises:
a local websocket client for connecting to the broadcast plugin which feeds audio of the producer's choice into the chat session for all (except the currently recording artist) to hear,
the same chat UI as the artist, except with extra features such as file and screen sharing, and
recording session management UI for controlling the details of the session, and who is currently recording.

The audio broadcast plugin 608 comprises:
a local websocket server for sending an audio track of the producer's choice to the producer's browser, which is inserted into the chat session for all (except the currently recording artist) to hear.

The au extra delay plugin 609 comprises:
a simple audio plugin for informing the DAW to add some extra latency to its total audio latency. This is because each plugin is only allotted a small amount of latency compensation, and the producer may want more. and
a local websocket client, for “inter plugin communication” with the recording plugin, to inform it of how much extra latency compensation it has added to the system.

The Stude server 603 a) acts as a WebRTC signaling server (https://bloggeek.me/webrtc-server/) b) acts as a text chat and file sharing server c) relays messages to start and stop recording, metrics about artist hardware, error messages and statistics from the DAW plugin to the producer's browser, etc. and d) does authentication and account management for producers to create new sessions, make purchases, change their details, change passwords etc.

The Stude server 603 comprises:
a Socket.io Server for doing real-time messaging between: DAW recording plugin, producer browser open on Stude webpage 607, and artist browser open on Stude webpage 604, and
a Node.JS web application for serving the HTML content of the service and providing APIs for interacting with the service. This comprises:
   serving of webpages,
   a database containing session info and user account information, and
   page templates for the pages viewed by artists, producers, and the general public.

Audio packets move from the DAW to the recording plugin though the standard API of the DAW's plugin interface, for example, VST (Virtual Studio Technology) or AU (AudioUnits) or any other plugin format.

The audio recording plugin 606 provides the DAW 605 with the predetermined latency (latency predelay).

When an artist is chosen for recording with the producer session management UI, the audio recording plugin 606 communicates with both the socket.io server on the Stude server 603 and the STUN/TURN server 602 to establish a peer-to-peer communication session through WebRTC, between the producer computer 601 and the browser running on the artist device 604.

The recording plugin automatically detects the movement of the DAW's transport, and uses this to initiate the latency-compensated audio stream between the recording plugin and the artist browser, whilst simultaneously taking the chosen artist out of the session chat channel. When the transport stops, the artist is added back to the chat. In this way, the producer and artist are able to communicate up until the instant when recording begins, and automatically be able to chat again as soon as recording stops. Also, the other participants in the session do not hear the recording artist in the chat, but only the backing track plus latency compensated audio from the broadcast plugin. In this way, the above described system and methods provide a seamless transition of the recorded artist between performing and interacting in the chat.

FIG. 7 illustrates a method performed by a first device, or producer device according to an embodiment. At S701, a first audio packet is sent from a first device to a second device. At S702, the first device receives a second audio packet from the second device. At S703, the second audio packet is delayed at the first device by a second latency. The second latency is determined so that a total delay between the first audio packet and the second audio packet at the first device equals a fixed audio packet delay for the recording session. This may be 1 second, or any other time value.

FIG. 8 illustrates a method performed by a second device, or artist device according to an embodiment. At S801, a first audio packet is received by the second device from the first device. At S802, the first audio packet is delayed by a first latency at the second device, before being played (S803) at the second device. While the first audio packet is playing, a person may begin singing performing. The singing/performing is then recorded as a second audio packet at the second device (S704), before being sent to the first device (S705). The second latency is determined so that a total delay between the first audio packet and the second audio packet at the first device equals a fixed audio packet delay for the recording session. This may be 1 second, or any other time value.

While certain arrangements have been described, the arrangements have been presented by way of example only, and are not intended to limit the scope of protection. The inventive concepts described herein may be implemented in a variety of other forms, In addition, various omissions, substitutions and changes to the specific implementations described herein may be made without departing from the scope of protection defined in the following claims.

1. A method of making an audio recording in a recording session, the method comprising:
sending a first audio packet from a first device to a second device, the first audio packet comprising a portion of a first audio signal for playback at the second device;
receiving at the first device a second audio packet from the second device, the second audio packet comprising a portion of a second audio signal, the second audio signal being created at the second device during playback of the first audio signal by the second device;
delaying the second audio packet by a first adjustment latency, wherein the first adjustment latency is set so that a total delay between the first audio packet sent by the first device and the second audio packet received by the first device from the second device equals a fixed audio packet delay for the recording session.

2. A method according to claim 1 wherein the first adjustment latency is determined based on the fixed audio packet delay, a latency of a browser running on the second device, a round trip delay, and a second adjustment latency, wherein the round trip delay is the time it takes for a packet to be sent from the first device to the second device, and from the second device to the first device, wherein the second adjustment latency is a delay of the first audio packet at the second device.

3. A method according to claim 2 further comprising:
prior to sending the first audio packet to the second device,
adding a timestamp to the first audio packet,
receiving a third audio packet from the second device, wherein the third audio packet comprises the timestamp from the first audio packet; and
determining a round trip delay based on the timestamp.

4. A method according to claim 2 further comprising:
determining the latency of the browser by:
receiving, from the second device, a delay between a first audio test signal played on the second device and a second audio test signal recorded on the second device, wherein the second audio test signal is a recording of the first audio test signal being played on the second device.

5. A method according to claim 1 further comprising, wherein the first device and the second device comprise at least one buffer, wherein if the total delay between the first audio packet sent by the first device and the second audio packet received by the first device from the second device exceeds the fixed audio packet delay or if a buffer of the first device or second device is empty,
discarding the first audio packet, the second audio packet, and packets in the at least one buffer of the first device and the at least one buffer of the second device.

6. A method according to claim 1, wherein the first device and the second device comprise at least one buffer, the method further comprising:
prior to sending the first audio packet to the second device, sending a control packet from the first device to the second device, wherein the control packet indicates to the second device to empty the at least one buffer on the second device.

7. A method according to claim 6, where the control packet indicates to the second device to commence sending of audio packets from the second device to the first device.

8. A method of making an audio recording in a recording session, the method comprising:
receiving, by a second device, a first audio packet from a first device, the first audio packet comprising a portion of a first audio signal for playback at the second device;
delaying, by the second device, the first audio packet by a second adjustment latency;
playing the first audio packet at the second device;
recording a second audio packet at the second device, the second audio packet comprising a portion of a second audio signal, the second audio signal being created at the second device during playback of the first audio signal by the second device;
sending the second audio packet from the second device to the first device;
wherein the second adjustment latency is set so that a total delay between the first audio packet sent by the first device and the second audio packet received by the first device from the second device equals a fixed audio packet delay for the recording session.

9. A method according to claim 8 wherein the second adjustment latency is determined based on the fixed audio packet delay and a latency of a browser running on the second device.

10. A method according to claim 9 further comprising:
on receiving the first audio, adding, by the second device, a timestamp from the first audio packet to a third audio packet, the third audio packet recorded at the second device; and
sending the third audio packet to the first device.

11. A method according to claim 9 further comprising
determining the latency of the browser by:
playing a first audio test signal on the second device;
recording a second audio test signal, wherein the second audio test signal is a recording of the first audio test signal being played at the second device;
determining a delay between the audio test signal and the recorded audio test signal at the first device; and
sending, to the first device, the delay between the audio test signal and the recorded audio test signal at the first device.

12. A method according to claim 8 further comprising: wherein the first device and second device comprise at least one buffer, wherein if the total delay between the first audio packet sent by the first device and the second audio packet received by the first device from the second device exceeds the fixed audio packet delay, or if a buffer of the first device or second device is empty,
discarding the first audio packet, the second audio packet, and packets in the at least one buffer of the second device and the at least one buffer of the first device.

13. A method according to claim 8, wherein the first device and the second device comprise at least one buffer, the method further comprising:
prior to sending the first audio packet to the second device, receiving, by the second device, a control packet from the first device to the second device;
in response to receiving the control packet, emptying, by the second device, the at least one buffer on the second device.

14. A non-transitory storage media comprising instructions that when executed by a computer, causes the computer to perform the method of claim 1.

15. A producer device suitable for use in a recording session, the producer device comprising a processor, memory and a communications interface, the producer device configured to:
send a first audio packet to an artist recording device, the first audio packet comprising a portion of a first audio signal for playback at the artist recording device;
receive a second audio packet from the artist recording device, the second audio packet comprising a portion of a second audio signal, the second audio signal being created at the artist recording device during playback of the first audio signal by the artist recording device; and
delay the second audio packet by a first adjustment latency, wherein the first adjustment latency is set so that a total delay between the first audio packet sent by the producer device and the second audio packet received at the producer device from the artist recording device equals a fixed audio packet delay for the recording session.

16. A producer device according to claim 15 wherein the first adjustment latency is determined based on the fixed audio packet latency, a latency of a browser running on the second device, a round trip delay, and a second adjustment latency, wherein the round trip delay is the time it takes for a packet to be sent from the first device to the second device, and from the second device to the first device, wherein the second adjustment latency is a delay of the first audio packet at the second device.

17. A producer device according to claim 16, the producer device further configured to:
prior to sending the first audio packet to the artist recording device,
add a timestamp to the first audio packet,
receiving a third audio packet from the second device, wherein the third audio packet comprises the timestamp from the first audio packet; and
determine a round trip delay based on the timestamp.

18. A producer device according to claim 16, the producer device further configured to:
determine the latency of the browser by:
receiving from the artist recording device a delay between a first audio test signal played on the artist recording device and a second audio test signal recorded on the artist recording device, wherein the second audio test signal is a recording of the first audio test signal being played at the artist recording device.

19. A producer device according to claim 15, the producer device further configured to:
wherein the producer device and artist recording device comprise at least one buffer, wherein if the total delay between the first audio packet sent by the producer device and the second audio packet received by the producer device from the artist recording device exceeds the fixed audio packet delay or if a buffer of the producer device or artist recording device is empty:
discard the first audio packet, the second audio packet, and packets in the at least one buffer of the producer device and the at least one buffer of the artist recording device.

20. An artist recording device suitable for use in a recording session, the artist recording device comprising a processor, memory, a communications interface, and an audio transducer, the artist recording device configured to:
receive a first audio packet from a producer device, the first audio packet comprising a portion of a first audio signal for playback at the second device;
delay the first audio packet by a second adjustment latency;
play the first audio packet at the artist recording device;
record a second audio packet at the artist recording, the second audio packet comprising a portion of a second audio signal, the second audio signal being created at the second device during playback of the first audio signal by the second device;
send the second audio packet from the artist recording device to the producer device;
wherein the second adjustment latency is set so that a total delay between the first audio packet sent by the producer device and the second audio packet received by the producer device from the artist recording device equals a fixed audio packet delay for the recording session.

21. An artist recording device according to claim 20 wherein the second adjustment latency is determined based on the fixed audio packet delay and a latency of a browser running on the artist recording device.

22. An artist recording device according to claim 21, the artist recording device further configured to:
on receiving the first audio packet, add a timestamp from the first audio packet to a third audio packet, the third audio packet recorded at the second device; and
sending the third audio packet to the first device.

23. An artist recording device according to claim 21, the artist recording device further configured to:
determine the latency of the browser by:
playing a first audio test signal on the artist recording device;
recording a second audio test signal, wherein the second audio test signal is a recording of the first audio test signal being played at the artist recording device;
determining a delay between the audio test signal and the recorded audio test signal at the artist recording device; and
sending, to the producer device, the delay between the audio test signal and the recorded audio test signal at the artist recording device.

24. An artist recording device according to claim 20, the artist recording device further configured to:
wherein the producer device and artist recording device comprise at least one buffer, wherein if the total delay between the first audio packet sent by the producer device and the second audio packet received by the producer device from the artist recording device exceeds the fixed audio packet delay, or if a buffer of the producer device or artist recording device is empty:
discard the first audio packet, the second audio packet, and packets in the at least one buffer of the artist recording device and the at least one buffer of the producer device.

25. A system comprising a producer device according to claim 15 and an artist recording device suitable for use in a recording session, the artist recording device comprising a processor, memory, a communications interface, and an audio transducer, the artist recording device configured to:
receive a first audio packet from a producer device, the first audio packet comprising a portion of a first audio signal for playback at the second device;
delay the first audio packet by a second adjustment latency;
play the first audio packet at the artist recording device;
record a second audio packet at the artist recording, the second audio packet comprising a portion of a second audio signal, the second audio signal being created at the second device during playback of the first audio signal by the second device;
send the second audio packet from the artist recording device to the producer device;
wherein the second adjustment latency is set so that a total delay between the first audio packet sent by the producer device and the second audio packet received by the producer device from the artist recording device equals a fixed audio packet delay for the recording session.
